(19) United States
(12) Patent Application Publication
(10) Pub. No.: US 2025/0322572 A1
(43) Pub. Date: Oct. 16, 2025

(54) CONTROL APPARATUS AND CONTROL METHOD FOR SAME

(71) Applicant: CANON KABUSHIKI KAISHA, Tokyo (JP)

(72) Inventor: FUMIHIKO KATO, Kanagawa (JP)

(21) Appl. No.: 19/169,150

(22) Filed: Apr. 3, 2025

(30) Foreign Application Priority Data
Apr. 12, 2024 (JP) 2024-064796

(51) Int. Cl. G06T 11/60; G06F 3/04845; G06T 7/11; H04N 23/695

(52) U.S. Cl. CPC G06T 11/60; G06F 3/04845; G06T 7/11; H04N 23/695; G06T 2207/20132

(57) ABSTRACT

The image capturing device has a tracking function for tracking and capturing a video of a subject, and a crop function for generating a crop video. The control apparatus sets a target position in the captured video within which the subject is to stay in the tracking function; sets a crop region in the captured video that is to be cut out by the crop function; and causes a display unit to display a GUI for receiving at least one of a setting of the target position and a setting of the crop region. In the displaying, a first GUI component and a second GUI component that respectively indicate the target position and the crop region are displayed.

### BACKGROUND OF THE INVENTION

### Field of the Invention

The present invention relates to control for tracking a subject.

### Description of the Related Art

Among cameras whose panning, tilting, and zooming can be controlled (PTZ cameras), a technique is known of detecting a tracking-target subject designated by a user from a captured image and automatically tracking the subject. Japanese Patent Laid-Open No. 2021-108425 discloses a method that makes it possible to designate a target position in which the subject is to be automatically tracked. According to this method, as a result of a camera operator adjusting the target position, the subject can be continuously captured at the desired position.

However, in a case in which automatic tracking is performed while an image is being captured with a zoomed-in angle of view (angle of view in which a large proportion of the image capturing angle of view is occupied by the subject), the subject may be lost should movement of the subject occur. It is conceivable to suppress subject loss by performing automatic tracking control while capturing an image with a wider angle of view than the above-described zoomed-in angle of view. However, if the angle of view desired by a user is a zoomed-in angle of view, it becomes necessary to separately cut out, by cropping, an area corresponding to the zoomed-in angle of view. In such a case, a complexity would arise in that, upon setting the target position in automatic tracking, the user would have to carry out the setting operation with a crop frame in mind, and this would become a significant burden for the user.

### SUMMARY OF THE INVENTION

According to one aspect of the present invention, a control apparatus that controls an image capturing device, the image capturing device having a tracking function for tracking and capturing a video of a subject, and a crop function for generating a crop video obtained by cropping the captured video and cutting out a partial region from the captured video, and the control apparatus comprises: a processor; and a memory containing instructions that, when executed by the processor, cause the processor to: set, to the image capturing device, a target position in the captured video within which the subject is to stay in the tracking function; set, to the image capturing device, a crop region in the captured video that is to be cut out by the crop function; and cause a display unit to display a graphical user interface (GUI) for receiving at least one of a setting of the target position and a setting of the crop region, wherein, in the displaying, a first GUI component and a second GUI component that respectively indicate the target position and the crop region are displayed on the display unit.

According to another aspect of the present invention, a control apparatus that controls an image capturing device, the image capturing device having a tracking function for tracking and capturing a video of a subject, and a crop function for generating a crop video obtained by cropping the captured video and cutting out a partial region from the captured video, and the control apparatus comprises: a processor; and a memory containing instructions that, when executed by the processor, cause the processor to: select a subject to be a tracking target in the tracking function from among a plurality of subjects in the captured video, and set the selected subject to the image capturing device; set, to the image capturing device, a crop region in the captured video that is to be cut out by the crop function; and display, on a display unit, a graphical user interface (GUI) for receiving at least one of a selection of the subject and a setting of the crop region, wherein, in the displaying, a first GUI component and a second GUI component respectively indicating the selected subject and the crop region are displayed on the display unit.

According to the present disclosure, the complexity involved in setting in automatic tracking control is reduced.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating an overall system configuration.

FIG. 2 is a diagram illustrating hardware configurations of apparatuses.

FIG. 3 is a flowchart of tracking operations.

FIGS. 4A to 4F are diagrams for describing a problem with automatic tracking.

FIGS. 5A to 5F are diagrams for describing generation of a picture-in- picture screen.

FIG. 6 is a flowchart of automatic tracking setting (first embodiment).

FIGS. 7A to 7F are diagrams for describing display in a GUI (first embodiment).

FIG. 8 is a flowchart of automatic tracking setting (second embodiment).

FIGS. 9A to 9D are diagrams for describing display in a GUI (second embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As a first embodiment of a control apparatus according to the present invention, description will be provided in the following taking as an example a controller that controls a PTZ camera.

### Overall System Configuration and Configurations of Individual Apparatuses

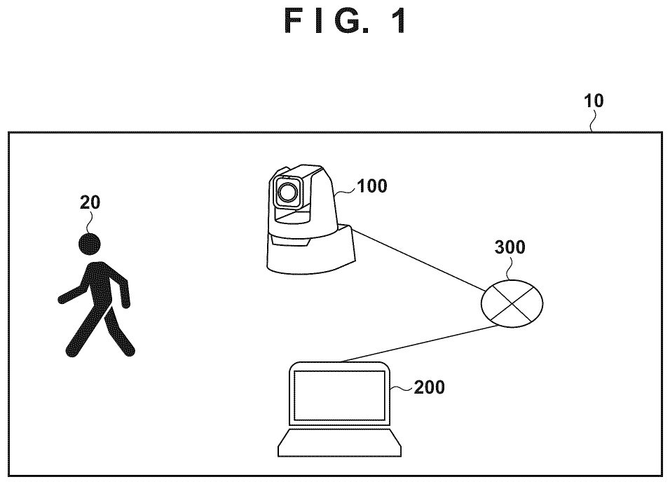

FIG. 1 is a diagram illustrating an overall configuration of an automatic tracking system 10. The automatic tracking system 10 includes a camera 100 and a controller 200. The camera 100 is an image capturing device for capturing an image of a subject 20, and the controller 200 is a control apparatus for remotely controlling the camera 100. The camera 100 and the controller 200 are configured to be capable of performing data communication with one another via a network 300. Examples of the network 300 include networks such as a local area network (LAN) and the Internet. Note that any form of connection and communication protocol may be adopted as long as mutual communication can be performed. For example, the apparatuses may be directly connected using a serial communication cable without using a network.

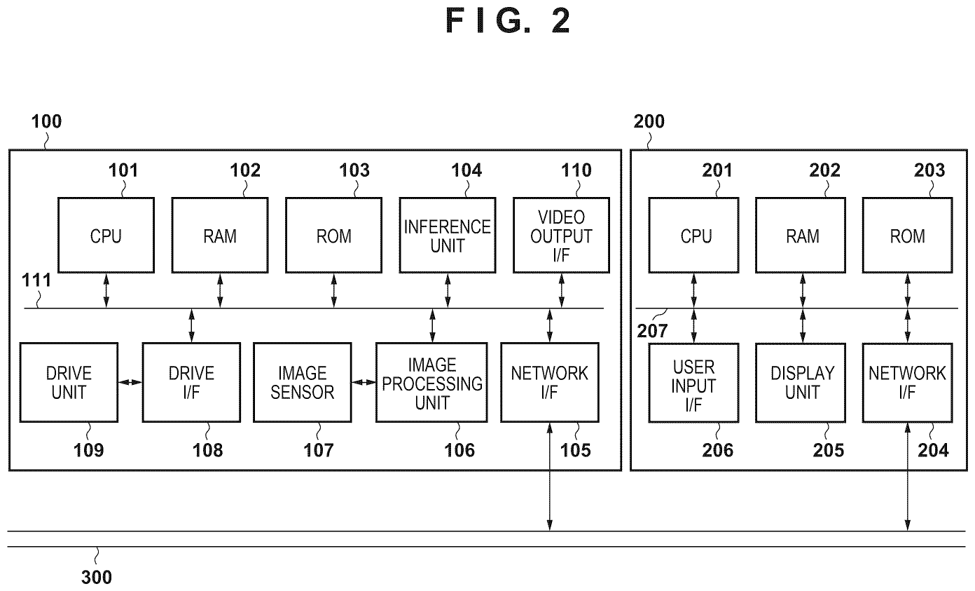

FIG. 2 is a diagram illustrating hardware configurations of the camera 100 and the controller 200. Note that the configurations illustrated in FIG. 2 are mere examples of the hardware configurations of the camera 100 and the controller 200, and may be changed and modified as appropriate.

The camera 100 includes a mechanism that can control panning, tilting, and zooming (PTZ) for changing the image capturing direction and image capturing angle of view. Furthermore, the camera 100 has a tracking function for detecting the subject from the captured image and tracking the subject by autonomously changing the image capturing direction based on the result of the detection. Note that description will be provided in the following assuming that the camera 100 is a camera of which the panning, tilting, and zooming are performed optically, and in which crop processing (crop function) is additionally executed by an image processing unit 106. However, the camera 100 may be a camera that performs panning, tilting, and zooming digitally as a result of the crop processing by the image processing unit 106.

A CPU 101 executes various types of processing using one or more computer programs and data stored in a RAM 102. Thus, the CPU 101 controls the operation of the entire camera 100, and also executes or controls the various types of processing described later as processing executed by the camera 100.

The RAM 102 is a high-speed storage device such as a DRAM. The RAM 102 includes an area for storing one or more computer programs and data loaded from a ROM 103, and an area for storing the captured image output from the image processing unit 106. Furthermore, the RAM 102 includes an area for storing various types of information received from the controller 200 via a network interface (I/F) 105, and a work area used by the CPU 101 and an inference unit 104 to execute various types of processing. In such a manner, the RAM 102 can provide, as appropriate, areas for storing various types of data.

The ROM 103 is a non-volatile storage device such as a flash memory, an HDD, an SSD, or an SD card. The ROM 103 has stored therein setting data of the camera 100, one or more computer programs and data relating to the activation of the camera 100, one or more computer programs and data relating to basic operations of the camera 100, etc. Furthermore, the ROM 103 has also stored therein one or more computer programs and data for causing the CPU 101 and the inference unit 104 to execute or control the various types of processing described later as processing executed by the camera 100.

The inference unit 104 executes inference processing for estimating, from the captured image, the presence/absence of the subject, the position of the subject, etc. For example, the inference unit 104 is a computing device, such as a graphics processing unit (GPU), specializing in image processing and inference processing. While it is generally effective to use a GPU for inference processing, functions equivalent thereto may be realized using a reconfigurable logic circuit such as a field programmable gate array (FPGA). Furthermore, a configuration may be adopted such that part or all of the processing by the inference unit 104 is executed by the CPU 101.

The network I/F 105 is an interface for establishing connection with the network 300, and communicates with external apparatuses such as the controller 200 via a communication medium such as Ethernet (registered trademark). Note that a serial communication I/F may be separately prepared and used for communication.

The image processing unit 106 generates the captured image, which is data having a predetermined format, based on a video signal output from an image sensor 107. Furthermore, the image processing unit 106 outputs the generated captured image to the RAM 102 after compressing the captured image as necessary. Note that the image processing unit 106 may execute various types of processing such as image adjustment, such as color correction, exposure correction, and sharpness correction, crop processing for cutting out only a predetermined region, etc., on the video represented by the video signal acquired from the image sensor 107. Furthermore, such processing may be executed in accordance with instructions received from the controller 200 via the network I/F 105.

The image sensor 107 outputs the video signal based on an optical image of the subject that is imaged by an image capturing optical system. For example, a photodiode, a charge coupled device (CCD) sensor, a complementary metal oxide semiconductor (CMOS) sensor, or the like may be used as the image sensor 107.

A drive I/F 108 is an interface allowing instruction signals such as control signals to be transmitted and received between the CPU 101 and a drive unit 109. The drive unit 109 is a drive mechanism for changing the image capturing direction of the camera 100, and includes mechanical drive systems, drive-source motors, etc. In accordance with instructions received from the CPU 101 via the drive I/F 108, the drive unit 109 executes pan (P) control for changing the image capturing direction in the horizontal (left and right) direction, and tilt (T) control for changing the image capturing direction in the vertical (up and down) direction. Furthermore, the drive unit 109 also executes optical zoom (Z) control for optically changing the image capturing angle of view.

A video output I/F 110 is an interface for outputting, to the outside, the captured image generated by the image processing unit 106. For example, the video output I/F 110 is formed from an interface conforming to the serial digital interface (SDI) or the High-Definition Multimedia Interface (HDMI) (registered trademark).

The CPU 101, the RAM 102, the ROM 103, the inference unit 104, the network I/F 105, the image processing unit 106, the drive I/F 108, and the video output I/F 110 described above are connected to a system bus 111.

Furthermore, the image processing unit 106 is configured to be capable of outputting a crop video obtained by cutting out a predetermined region (crop region) of the captured image based on crop processing instructed by the CPU 101. For example, the CPU 101 retrieves a crop setting stored in the RAM 102 and instructs the image processing unit 106 to execute crop processing.

The controller 200 receives the captured image transmitted from the camera 100 via the network 300, and transmits control signals to the camera 100 via the network 300. For example, based on an operation received from a user, the controller 200 can transmit a target position (position within the captured video) of a tracking subject as a control signal to the camera 100. That is, by operating the controller 200, the user can instruct the camera 100 to capture an image while performing tracking.

A CPU 201 executes various types of processing using one or more computer programs and data stored in a RAM 202. Thus, the CPU 201 controls the operation of the entire controller 200, and also executes or controls the various types of processing described later as processing executed by the controller 200.

The RAM 202 is a high-speed storage device such as a DRAM. The RAM 202 includes an area for storing one or more computer programs and data loaded from a ROM 203, and an area for storing various types of data received from the camera 100 via a network I/F 204. Furthermore, the RAM 202 includes a work area used by the CPU 201 to execute various types of processing. In such a manner, the RAM 202 can provide, as appropriate, areas for storing various types of data.

The ROM 203 is a non-volatile storage device such as a flash memory, an HDD, an SSD, or an SD card. The ROM 203 has stored therein setting data of the controller 200, one or more computer programs and data relating to the activation of the controller 200, one or more computer programs and data relating to basic operations of the controller 200, etc. Furthermore, the ROM 203 has also stored therein one or more computer programs and data for causing the CPU 201 to execute or control the various types of processing described later as processing executed by the controller 200.

The network I/F 204 is an interface for establishing connection with the network 300, and communicates with external apparatuses such as the camera 100 via a communication medium such as Ethernet (registered trademark). For example, the communication between the controller 200 and the camera 100 includes the transmission of control commands to the camera 100, the reception of the captured image from the camera 100, etc.

A display unit 205 is a display unit including a screen such as a liquid-crystal display, and displays the captured image received from the camera 100, setting screens of the controller 200, etc. In the following, a case will be described in which the display unit 205 is a touchscreen that can receive operations from the user. Note that a configuration may be adopted such that the display unit 205 is formed as an external device, instead of being built into the controller 200. For example, an external display device may be connected to the controller 200, and a display control unit included in the controller 200 may display the captured image, setting screens, etc., on the external display device.

A user input I/F 206 is an interface for receiving operations on the controller 200 performed by the user. For example, the user input I/F 206 includes a mouse, a keyboard, a button, a dial, a joystick, a touchscreen, etc.

The CPU 201, the RAM 202, the ROM 203, the network I/F 204, the display unit 205, and the user input I/F 206 described above are connected to a system bus 207. Note that the controller 200 may also be formed from a personal computer (PC).

### Operations of Camera 100

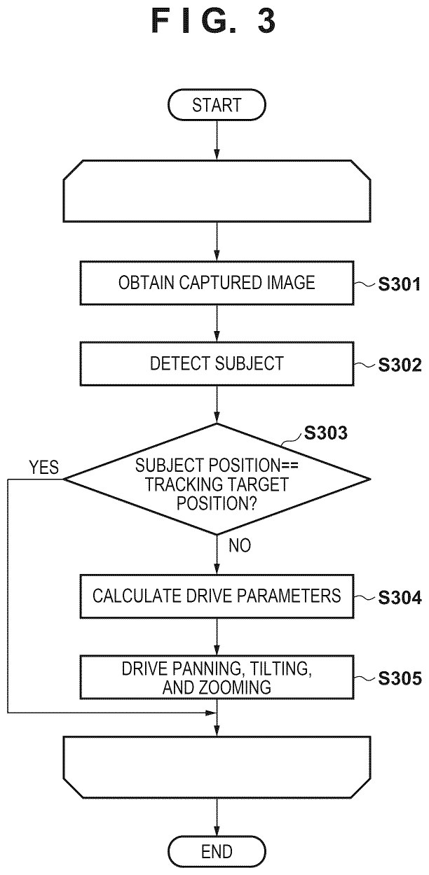

FIG. 3 is a flowchart of tracking operations by the camera. Specifically, FIG. 3 is a diagram for describing control by the camera 100 for detecting a subject and tracking the subject. FIG. 3 illustrates loop processing in which an image is captured, the position of the subject is specified from within the captured video, and the subject is tracked.

In step S301, the CPU 101 of the camera 100 acquires a captured image (frame image) from the image processing unit 106, and stores the captured image in the RAM 102.

In step S302, the CPU 101 detects a subject included in the captured video acquired in step S301. Specifically, the CPU 101 retrieves the captured image from the RAM 102, inputs the captured image to the inference unit 104, and stores, in the RAM 102, the subject type and position information (subject position) of the subject in the captured video inferred by the inference unit 104. The inference unit 104 includes a trained model created using a machine learning technique such as deep learning, and receives an image as input data, and outputs, as output data, a subject type such as a person, position information, and a score indicating reliability. Here, description is provided supposing that the position information is constituted from position coordinates of a target object (person's face) in the captured image.

In step S303, the CPU 101 determines whether or not the subject position of the subject included in the captured video acquired in step S301 and the position (target position) in which the subject is to be kept in the captured video match. Specifically, the CPU 101 determines whether or not the subject position stored in the RAM 102 in step S302 matches a target position designated in advance. Upon determining that the position information matches, the CPU 101 skips steps S304 and S305 and advances to the loop processing for the next captured image. On the other hand, the CPU 101 advances to step S304 upon determining that the position information does not match. Note that, preferably, a configuration is adopted such that it is regarded that the subject position and the target position match if the difference therebetween is within a predetermined range. Thus, excessive drive control of the camera 100 can be prevented.

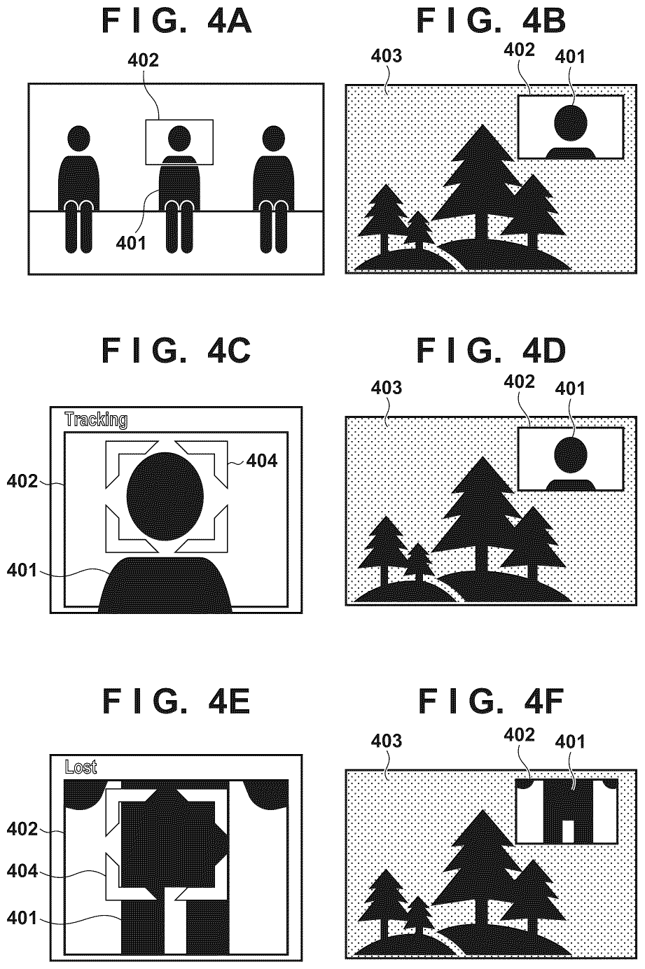

Here, the target position is stored in the RAM 102 by the CPU 101 upon system activation. Furthermore, as is the case with target position 404 to be described later with reference to FIGS. 4A to 4F, the target position may include information indicating the subject size (absolute size or relative size) in the captured video, in addition to information indicating coordinates (horizontal direction, vertical direction) in the captured video. For example, by setting a large target subject size in the captured video, a captured video in which the subject is shown in a larger size can be acquired. In such a manner, a captured video in which a subject is shown in the size desired by the user can be acquired in accordance with the target subject size. Note that any position, such as the center of the captured video, the position when the system was previously shut down, or a position designated in advance by the user, can be set as the target position in the captured video upon activation.

In step S304, the CPU 101 calculates pan and tilt (PT) control drive parameters that are necessary to match the subject position with the target position. Specifically, the CPU 101 derives a difference between the current subject position and the target position, and calculates drive parameters corresponding to the difference. Here, the drive parameters refer to parameters for controlling pan-direction and tilt-direction motors (unillustrated) included in the drive unit 109. Note that, if a target subject size is set, a parameter for controlling a zoom motor (unillustrated) is further calculated. The CPU 101 stores the calculated drive parameters in the RAM 202.

In step S305, the CPU 101 retrieves the drive parameters from the RAM 202, and controls the drive unit 109 via the drive I/F 108. Thus, the image capturing direction (pan and tilt directions) of the camera 100 is changed to an orientation such that the subject position and the target position match. Furthermore, the image capturing angle of view (zoom magnification) of the camera 100 is changed to an angle of view such that the subject size and the target subject size match.

### Problem with Tracking with Zoomed-in Angle of View

First, a problem occurring when the target position is controlled and automatic tracking is performed with a “zoomed-in angle of view” will be described with reference to FIGS. 4A to 4F. Note that a zoomed-in angle of view refers to an angle of view, such as that illustrated in FIG. 4C for example, in which a large proportion of an image capturing angle of view 402 is occupied by the subject.

FIG. 4A illustrates a video obtained by capturing, from the front, three people viewing a recorded video 403 (movie or the like). Furthermore, an image capturing angle of view 402 of the camera 100 capturing a subject 401 (one person) is also illustrated.

Each of FIGS. 4B, 4D, and 4F is a diagram schematically illustrating a superimposed video obtained by superimposing a captured video (video corresponding to image capturing angle of view 402) of the subject 401 on the recorded video 403 as a picture-in-picture screen. A picture-in-picture screen refers to a screen for superimposing and displaying a video on a partial region of a display screen.

Each of FIGS. 4C and 4E is a diagram schematically illustrating a graphical user interface (GUI) for setting a target position 404. Here, the target position 404 indicates a target region that is a “person's face” in the image capturing angle of view 402. As illustrated in FIG. 4C, by adopting a setting such that a large proportion of the image capturing angle of view 402 is occupied by the target position 404, automatic tracking can be performed such that the face of the subject 401 is shown in close-up. Furthermore, the superimposed video illustrated in FIG. 4B can be generated by superimposing the captured video as a picture-in-picture screen as illustrated in FIG. 4D.

However, if the subject 401 moves abruptly while automatic tracking is being executed, the face of the subject 401 may move outside the image capturing angle of view 402. For example, if the subject 401 stands up from the seated state illustrated in FIG. 4A, the face of the subject 401 would move outside the image capturing angle of view 402 (the face would be lost). Consequently, the video corresponding to the image capturing angle of view 402 captured by the camera 100 would be in a subject-lost state as illustrated in FIG. 4E. In this case, the superimposed video would be as illustrated in FIG. 4F. In particular, the subject-lost state readily occurs if a zoomed-in angle of view (angle of view in which a large proportion of the image capturing angle of view 402 is occupied by the subject) as illustrated in FIG. 4C is adopted.

### Automatic Tracking Combining Image Capturing with Wide Angle of View and Cropping

In view of this, in the first embodiment, a subject is captured in a video with a relatively wide angle of view compared to the above-described “zoomed-in angle of view”, and a picture-in-picture screen is generated by executing crop processing on the captured video with the wide angle of view. That is, a picture-in-picture screen that is a video corresponding to the “zoomed-in angle of view” is generated by executing crop processing on a captured video with a wide angle of view.

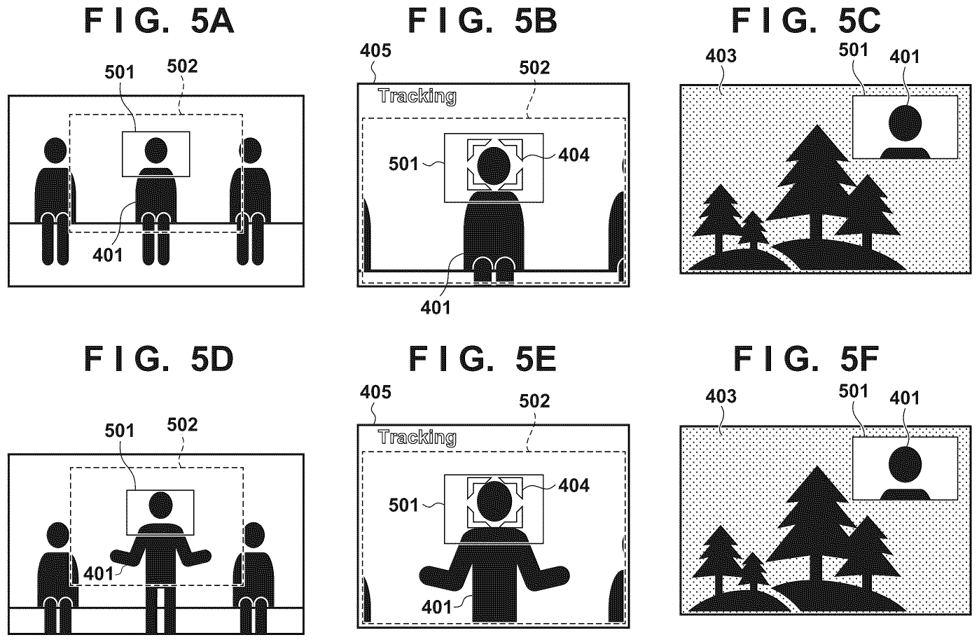

Each of FIGS. 5A and 5D illustrates a video obtained by capturing, from the front, three people viewing a recorded video 403. Furthermore, a crop region 501 and a tracking angle of view 502 of the camera 100 capturing a subject 401 (one person) are also illustrated.

Each of FIGS. 5B and 5E is a diagram schematically illustrating a GUI for setting a target position 404 in the captured video. Furthermore, each of FIGS. 5C and 5F is a diagram schematically illustrating a superimposed video obtained by superimposing a captured video of the subject 401 (video corresponding to the crop region 501) on the recorded video 403 as a picture-in-picture screen.

That is, as illustrated in FIG. 5A, the subject 401 is automatically tracked and captured in a video with the tracking angle of view 502, and a picture-in-picture screen is generated by cutting out the crop region 501 from the tracking angle of view 502. By setting the crop region 501 so as to be equivalent to the image capturing angle of view 402, a picture-in-picture screen with an angle of view equivalent to the image capturing angle of view 402 (zoomed-in angle of view) in FIG. 4A can be generated.

Because the tracking angle of view 502 is wider than the image capturing angle of view 402, the loss of the tracking target (here, a person's face) does not readily occur. That is, even if the subject moves abruptly (stands up) as illustrated in FIG. 5D, tracking can be continued normally as illustrated in FIG. 5E. Consequently, as illustrated in FIG. 5F, a superimposed video similar to that in FIG. 4B can be created.

### Operations of Controller 200

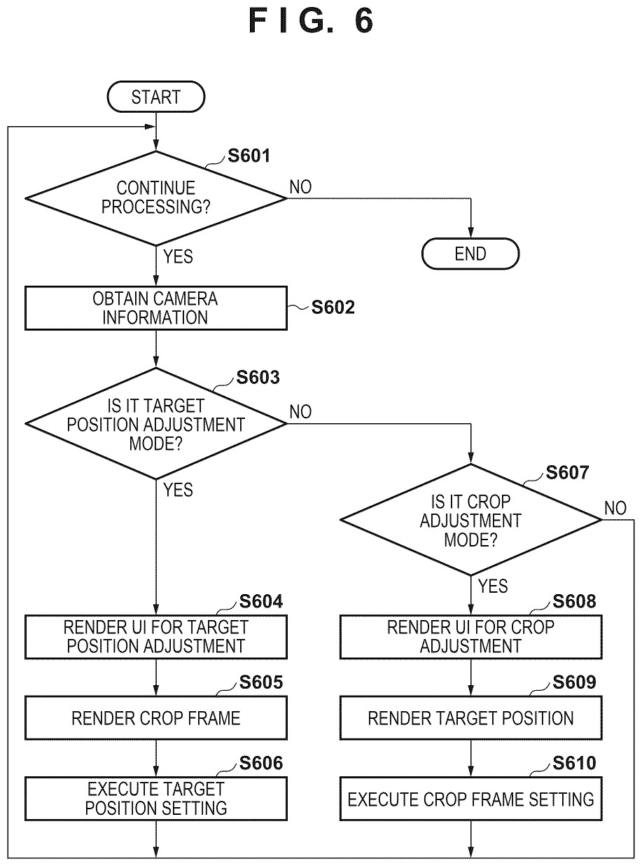

FIG. 6 is a flowchart of automatic tracking setting in the first embodiment. Specifically, FIG. 6 is a diagram describing operations by the controller 200 for setting a crop setting or a target position of the camera 100. In particular, the automatic tracking setting described in the following is characterized in that, rather than the crop setting and the setting of the target position being performed independently from one another, the crop setting and the target position can be set in association with one another.

In step S601, the CPU 201 of the controller 200 determines whether or not to continue the processing (control flow) in FIG. 6. For example, the CPU 201 determines whether or not to continue the processing by checking whether or not a command to terminate the present control flow has been received via the network I/F 204 or the user input I/F 206. The CPU 201 advances to step S602 upon continuing the present control, and otherwise terminates the present control.

In step S602, the CPU 201 acquires camera information of the camera 100. Here, the camera information is information including a captured image, and a target position and a crop setting. Specifically, the CPU 201 transmits a camera information acquisition request to the camera 100 via the network I/F 204. Upon receiving the camera information acquisition request, the CPU 101 of the camera 100 retrieves the captured image, the target position, and the crop setting stored in the RAM 102, and transmits the retrieved information to the controller 200 via the network I/F 105. The controller 200 stores the received camera information (the captured image, and the target position and the crop setting) in the RAM 202.

In step S603, the CPU 201 determines whether or not the setting mode is a target position adjustment mode. Specifically, the CPU 201 acquires the setting mode from the RAM 202, and advances to step S604 if the setting mode is the target position adjustment mode and otherwise advances to step S607. Note that setting modes include the target position adjustment mode for setting a target position, a crop adjustment mode for setting a crop frame, and other modes. If the setting mode is changed via the network I/F 204 or the user input I/F 206, the CPU 201 stores the changed setting mode in the RAM 202.

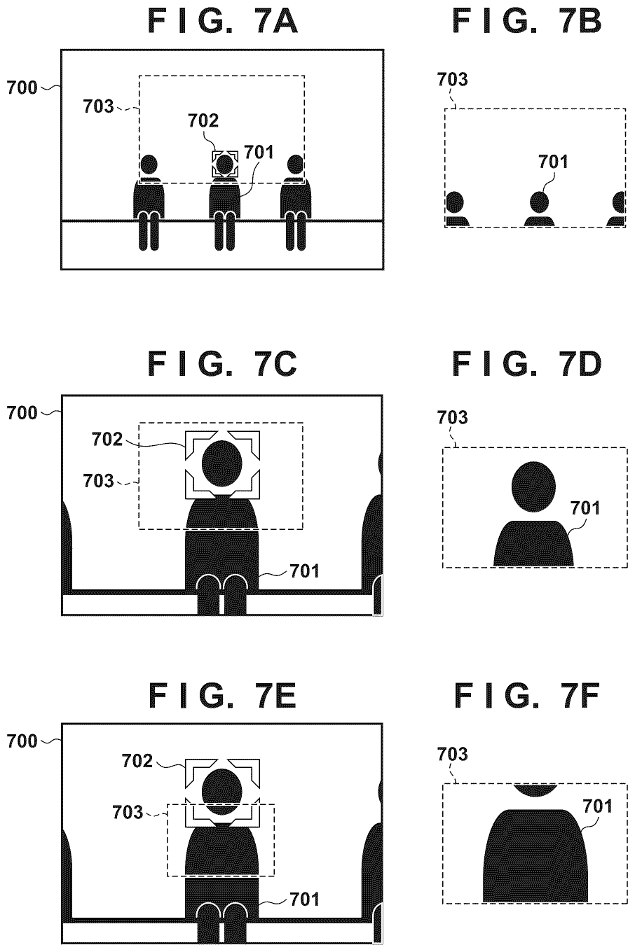

In step S604, the CPU 201 displays a graphical user interface (GUI) for target position adjustment. The GUI will be described in detail later with reference to FIGS. 7A to 7F. Specifically, the CPU 201 retrieves the captured image and the target position from the RAM 202, and displays the GUI for target position adjustment on the display unit 205.

Note that the GUI for target position adjustment may be any GUI as long as the user can visually recognize the target position. For example, a frame indicating coordinates on the captured image or an icon resembling a human body may be displayed. Furthermore, a subject detection frame created based on a subject position acquired from the camera 100 may also be displayed. In this case, information including the subject position is also received from the camera 100 in advance in step S602.

In step S605, the CPU 201 displays a crop frame (GUI component indicating an area subjected to crop processing) on the GUI. Specifically, the CPU 201 retrieves the crop setting from the RAM 202, and superimposes and displays a crop frame on the captured image displayed on the display unit 205.

Thus, the user can readily ascertain the area subjected to crop processing by the camera 100, and the target position or subject position. That is, the user can set automatic tracking while viewing the crop state.

In step S606, the CPU 201 executes target position setting. Specifically, the CPU 201 receives a target position change request from the user via the user input I/F 206. The user changes the target position based on the GUI displayed through steps S604 and S605. The CPU 201 transmits, to the camera 100 via the network I/F 204, the changed target position received via the user input I/F 206. Upon receiving the target position change instruction, the camera 100 stores the received target position in the RAM 102. Thus, the setting of the camera 100 can be changed so that the subject is captured in the changed target position.

Here, the GUI displayed on the display unit 205 and user operations will be described with reference to FIGS. 7A to 7D. FIGS. 7A to 7F are diagrams for describing display in the GUI in the first embodiment. The GUI is a user interface displayed on the display unit 205 for providing information to the user and also receiving operations from the user.

FIGS. 7A and 7C illustrate an example of the GUI obtained by superimposing GUI components (target position icon 702 and crop frame 703) on a video 700 obtained by capturing three people from the front. The target position icon 702 is a GUI component indicating the target position of the tracking target (face of a subject 701) in the captured image 700. Furthermore, the crop frame 703 is a GUI component indicating an area subjected to crop processing. Furthermore, FIGS. 7B and 7D are diagrams respectively illustrating images cut out by crop processing being performed with respect to FIGS. 7A and 7C.

In FIG. 7A, a small proportion of the crop frame 703 is occupied by the target position icon 702 (size of the target position). Furthermore, the target position icon 702 is set at the lower part of the crop frame 703. In this case, the image (crop image) cut out by crop processing would be as illustrated in FIG. 7B. That is, a crop image would be obtained in which the subject 701 is excessively small and only part of the subject 701 is included, and the user can recognize that the crop area and the target position are not set appropriately.

Thus, the user performs an operation to move the target position icon 702 to the desired position in the crop frame 703 while viewing the GUI displayed in step S606. For example, the user positions the target position icon 702 at the upper part of the crop frame 703 and enlarges size, as illustrated in FIG. 7C. Due to this positioning, the desired crop image is obtained as illustrated in FIG. 7D. That is, by adopting a GUI in which the user can change the target position in a state in which a crop frame and a target position icon are concurrently displayed, the complexity of the setting operation can be reduced.

In step S607, the CPU 201 determines whether or not the setting mode is the crop adjustment mode. The CPU 201 advances to step S608 if the setting mode is the crop adjustment mode and otherwise advances to step S601. In step S608, the CPU 201 displays a GUI for crop adjustment. The GUI will be described in detail later with reference to FIGS. 7A to 7F. Specifically, the CPU 201 retrieves the captured image and the crop setting from the RAM 202, and displays the GUI for crop adjustment on the display unit 205. Note that the GUI for crop adjustment may be any GUI as long as the user could visually recognize the crop region. For example, a rectangular frame indicating the crop region, characters indicating coordinates, or the like may be displayed on the captured image.

In step S609, the CPU 201 displays the target position (GUI component indicating the target of automatic tracking) on the GUI. Specifically, the CPU 201 retrieves the target position from the RAM 202, and superimposes and displays the target position on the captured image displayed on the display unit 205. Furthermore, a subject detection frame created based on a subject position acquired from the camera 100 may also be displayed. In this case, information including the subject position is also received from the camera 100 in advance in step S602.

Thus, the user can readily ascertain the area subjected to crop processing by the camera 100, and the target position or subject position. That is, the user can set the crop setting while viewing the automatic tracking setting state.

In step S610, the CPU 201 executes crop frame setting. Specifically, the CPU 201 receives a crop frame change request from the user via the user input I/F 206. The user changes the crop frame setting based on the GUI displayed through steps S608 and S609. The CPU 201 transmits, to the camera 100 via the network I/F 204, the changed crop frame setting received via the user input I/F 206. Upon receiving the crop frame setting change instruction, the camera 100 stores the received crop frame setting in the RAM 102. Thus, the setting of the camera 100 can be changed so that crop processing is executed using the changed crop frame setting.

Here, the GUI displayed on the display unit 205 and user operations will be described with reference to FIGS. 7C to 7F. FIGS. 7C and 7E illustrate an example of the GUI obtained by superimposing GUI components (target position icon 702 and crop frame 703) on a video 700 obtained by capturing a person from the front. The target position icon 702 is a GUI component indicating the target position of the tracking target (face of a subject 701) in the captured image 700. Furthermore, the crop frame 703 is a GUI component indicating an area subjected to crop processing. Furthermore, FIGS. 7D and 7F are diagrams respectively illustrating images cut out by crop processing being performed with respect to FIGS. 7C and 7E.

In FIG. 7E, the crop frame 703 is small. Furthermore, the crop frame 703 is misaligned with the target position icon 702. In this case, the image (crop image) cut out by crop processing would be as illustrated in FIG. 7F. That is, a crop image would be obtained in which the subject 701 is excessively large and only part of the subject 701 is included, and the user can recognize that the crop area and the target position are not set appropriately.

Thus, the user operates the crop frame 703 so that the target position icon 702 is positioned at the desired position in the crop frame 703 while viewing the GUI displayed in step S610. For example, the user moves the crop frame 703 and enlarges size so that the target position icon 702 is positioned at the upper part of the crop frame 703, as illustrated in FIG. 7C. Due to this positioning, the desired crop image is obtained as illustrated in FIG. 7D. That is, by adopting a GUI in which the user can change the target position in a state in which a crop frame and a target position icon are concurrently displayed, the complexity of the setting operation can be reduced.

As described above, according to the first embodiment, the setting of a crop frame and the setting of a target position in automatic tracking combining “image capturing with wide angle of view and cropping” are performed in association with one another. In particular, a GUI is provided in which the target position can be changed in a state in which a crop frame and a target position icon are concurrently displayed. The complexity of the setting operation can be reduced by using this GUI.

### Modifications

In the above-described first embodiment, description is provided that the complexity involved in setting the target position in automatic tracking in a region cut out by cropping is reduced; however, there is no limitation to this. For example, application is possible to setting for selecting the tracking subject to be automatically tracked.

For example, if the user would like to realize the picture-in-picture screen described with reference to FIGS. 5A to 5F with another subject, an operation for selecting the other subject as the tracking subject would be performed. In doing so, the other subject cannot be selected as the tracking subject if the other subject is not detected by the camera 100. Accordingly, when the operation for selecting a tracking subject is to be performed, one or more frames or the like resembling subject positions are displayed so that the user can recognize whether or not selection as the tracking subject is possible.

By displaying frames resembling subject positions on the same screen as the crop frame, the user can recognize whether other subjects can be selected as the tracking subject while viewing the crop frame, which constitutes the picture- in-picture screen. Thus, the user can immediately select other subjects when the user feels inclined to do so. Accordingly, the complexity involved in the setting operation for selecting a tracking subject to be automatically tracked can be reduced.

In this case, in step S602, the CPU 201 receives information including all detected subject positions from the camera 100, and stores the information in the RAM 202. Next, in step S604, the CPU 201 retrieves all detected subject positions, and displays, based on the retrieved subject positions, a subject-designation GUI in which frames or the like resembling the subject positions are displayed. Then, in step S606, the CPU 201 receives a tracking subject change request from the user, and instructs the camera 100 to change the tracking target to the tracking subject designated by the user.

Furthermore, in the first embodiment, description is provided that a GUI displaying GUI components for both the crop frame setting and the target position setting is displayed on the display unit 205. However, a configuration may be adopted in which the individual GUI components can be displayed individually. In this case, the CPU 201 stores, in the RAM 202, a target position display flag and a crop frame display flag in accordance with a designation by the user of whether or not display is to be performed. Each flag indicates “display on” if the flag is on (or 1), and “display off” if the flag is off (or 0). In steps S604 and S609, the CPU 201 displays the target position on the display unit 205 if the target position display flag is on (or 1). Furthermore, in steps S605 and S608, the CPU 201 displays the crop frame on the display unit 205 if the crop frame display flag is on (or 1). Thus, in accordance with designations by the user, it can be set whether GUI components for the crop frame setting and the target position setting are to be displayed.

Note that, for simplicity of description, description is provided in the first embodiment assuming that the image processing unit 106 of the camera 100 processes one crop region; however, the number of crop regions is not limited to this. If a plurality of crop settings can be set, the CPU 201 displays a plurality of crop frames of the display unit 205. Thus, application is also possible to a camera that has a plurality of crop settings and that can generate a plurality of crop videos.

### Second Embodiment

In the above-described first embodiment, description is provided that a target position icon and a crop frame are displayed in the GUI regardless of whether or not a video cut out by cropping is being output to the video output I/F 110. In the second embodiment, an embodiment will be described in which GUI display is adjusted depending on whether or not a video cut out by cropping is being output to the video output I/F 110. In particular, an embodiment will be described in which a crop frame is displayed only if the controller 200 is in the target position setting mode and a video cut out by cropping is being output to the video output I/F 110. Note that, because the overall system configuration, the configurations of the apparatuses, and the operations of the camera are similar to those in the first embodiment (FIGS. 1 to 3), description thereof is omitted.

### Operations of Controller 200

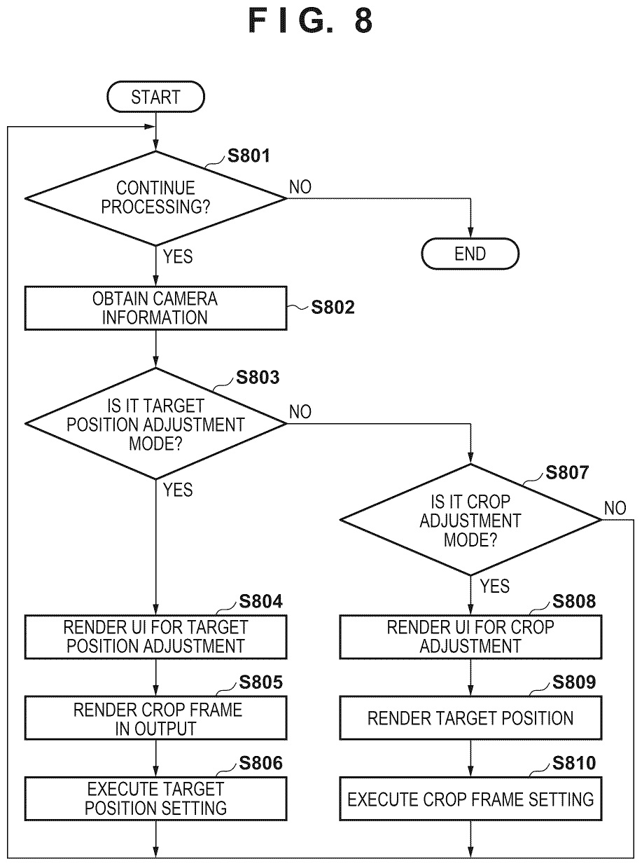

FIG. 8 is a flowchart of automatic tracking setting in the second embodiment. Note that steps S801, S803, and S804, and steps S806 to S810 are similar to steps S601, S603, and S604, and steps S606 to S610 in the first embodiment, and description thereof is thus be omitted.

In step S802, the CPU 201 acquires camera information of the camera 100. Here, the camera information is information including a captured image, and a target position and a crop setting. However, there is a difference from the first embodiment in that the crop setting includes information as to whether or not a video subjected to crop processing is being output to the video output I/F 110, which is an output unit. Furthermore, while description is provided here regarding a case in which there is one video output I/F 110 and one crop setting for simplicity of description, a configuration may be adopted in which there are a plurality of video output I/Fs 110 and a plurality of crop settings. If there are a plurality of video output I/Fs 110 and a plurality of crop settings, a configuration is adopted such that output information indicating which crop video based on which crop setting is applied to each video output I/F 110.

In step S805, the CPU 201 displays a crop frame on the GUI as necessary. Specifically, the CPU 201 retrieves the crop setting from the RAM 202, and based on the retrieved crop setting, determines whether or not a crop video is being output to the video output I/F 110. If a crop video is being output to the video output I/F 110, a crop frame corresponding to the output crop video is superimposed and displayed on the captured image displayed on the display unit 205.

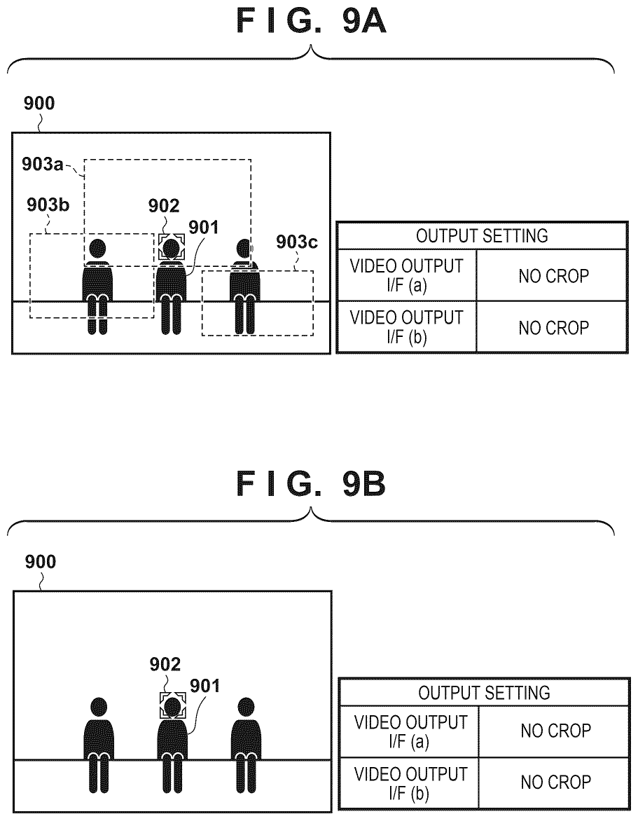

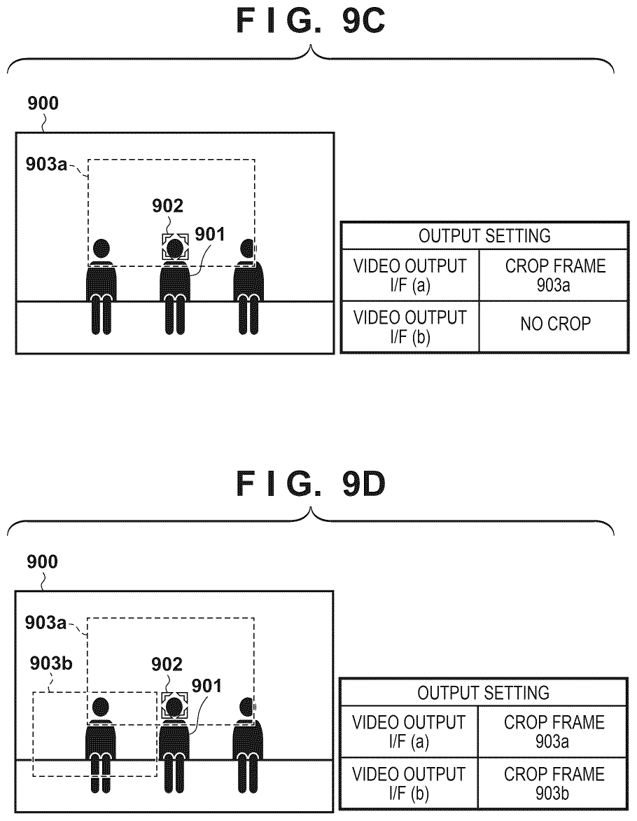

Here, with reference to FIGS. 9A to 9D, description will be provided of the user operations and the GUI displayed on the display unit 205 (only if a crop video is being output to the video output I/F 110). FIGS. 9A to 9D are diagrams for describing display in the GUI in the second embodiment. The GUI is a user interface displayed on the display unit 205 for providing information to the user and also receiving operations from the user.

Here, in order to facilitate understanding of the description, a case will be described in which two video output I/Fs 110, namely I/F (a) and I/F (b), are included, and three crop settings are included. Note that the specific allocation of the crop settings to the video output I/Fs 110 is managed by means of output settings. FIG. 9A illustrates an example of the GUI obtained by superimposing GUI components (target position icon 902 and three crop frames 903a to 903c) on a video 900 obtained by capturing three people from the front. The target position icon 902 is a GUI component indicating the target position of the tracking target (face of a subject 901) in the captured image 900.

In FIG. 9A, the output settings of both video output I/F (a) and video output I/F (b) indicate “no crop”. However, because crop frames 903 are rendered regardless of the output from the video output I/Fs 110 in FIG. 9A, the three crop frames 903a to 903c and the target position icon 902 are rendered on the GUI. Thus, the visibility of the target position icon 902 is low.

In view of this, in the second embodiment, the visibility of the target position icon 902 is improved by rendering crop frames 903 in accordance with the output from the video output I/Fs 110, as illustrated in FIGS. 9B to 9D.

In FIG. 9B, the output settings of both video output I/F (a) and video output I/F (b) indicate “no crop”, as is the case in FIG. 9A. In this case, none of the three crop frames 903a to 903c are rendered, and only the target position icon 902 is rendered on the GUI.

In FIG. 9C, the output setting of the video output I/F (a) and the output setting of the video output I/F (b) are “crop 903a” and “no crop”, respectively. In this case, the crop frame 903a is rendered in addition to the target position icon 902. Thus, the complexity involved in setting the target position icon 902 in relation to the crop frame 903a can be reduced.

In FIG. 9D, the output setting of the video output I/F (a) and the output setting of the video output I/F (b) are “crop 903a” and “crop 903b”, respectively. In this case, the crop frames 903a and 903b are rendered in addition to the target position icon 902. Thus, the complexity involved in setting the target position icon 902 in relation to the crop frames 903a and 903b can be reduced.

As described above, according to the second embodiment, GUI display is adjusted depending on whether or not a video cut out by cropping is being output to a video output I/F 110. The setting of the target position icon 902 in relation to a crop frame can be facilitated by displaying, on the GUI, only a crop frame corresponding to a crop video being output to a video output I/F 110.

Note that, in the second embodiment, description is provided that a GUI displaying GUI components for both the crop frame setting and the target position setting is displayed on the display unit 205. However, similarly to the configuration described in the modifications of the first embodiment, a configuration may be adopted in which the individual GUI components can be displayed individually.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064796, filed Apr. 12, 2024 which is hereby incorporated by reference herein in its entirety.

What is claimed is:

1. A control apparatus that controls an image capturing device, the image capturing device having a tracking function for tracking and capturing a video of a subject, and a crop function for generating a crop video obtained by cropping the captured video and cutting out a partial region from the captured video, and
the control apparatus comprising:
a processor; and
a memory containing instructions that, when executed by the processor, cause the processor to:
set, to the image capturing device, a target position in the captured video within which the subject is to stay in the tracking function;
set, to the image capturing device, a crop region in the captured video that is to be cut out by the crop function; and
cause a display unit to display a graphical user interface (GUI) for receiving at least one of a setting of the target position and a setting of the crop region,
wherein, in the displaying, a first GUI component and a second GUI component that respectively indicate the target position and the crop region are displayed on the display unit.

2. The control apparatus according to claim 1,
wherein, in the displaying, the first GUI component and the second GUI component are superimposed and displayed on the captured video.

3. The control apparatus according to claim 1,
wherein the instructions further cause the processor to obtain, from the image capturing device, a captured image captured by the image capturing device, a setting of the target position set to the image capturing device, and a setting of the crop region set to the image capturing device, and
in the displaying, the first GUI component is displayed based on the obtained setting of the target position, and the second GUI component is displayed based on the obtained setting of the crop region.

4. The control apparatus according to claim 3,
wherein, in the displaying, moving and/or transforming of the first GUI component is received in a first setting mode for receiving a setting of the target position, and moving and/or transforming of the second GUI component is received in a second setting mode for receiving a setting of the crop region.

5. The control apparatus according to claim 3,
wherein the crop function is capable of generating a plurality of crop videos each obtained by cutting out a different partial region from the captured video,
the image capturing device comprises an output unit that outputs one or more crop videos included in the plurality of crop videos,
in the obtaining, output information relating to a crop video being output from the output unit is further obtained, and
in the displaying, the second GUI component is displayed based on only a setting of a crop region corresponding to the crop video indicated by the output information.

6. The control apparatus according to claim 3,
wherein the instructions further cause the processor to receive a first designation relating to whether or not the first GUI component is to be displayed in the GUI, and a second designation relating to whether or not the second GUI component is to be displayed in the GUI, and
in the displaying, a determination of whether or not to display the first GUI component in the GUI is made based on the first designation, and a determination of whether or not to display the second GUI component in the GUI is made based on the second designation.

7. A control apparatus that controls an image capturing device,
the image capturing device having a tracking function for tracking and capturing a video of a subject, and a crop function for generating a crop video obtained by cropping the captured video and cutting out a partial region from the captured video, and
the control apparatus comprising:
a processor; and
a memory containing instructions that, when executed by the processor, cause the processor to:
select a subject to be a tracking target in the tracking function from among a plurality of subjects in the captured video, and set the selected subject to the image capturing device;
set, to the image capturing device, a crop region in the captured video that is to be cut out by the crop function; and
display, on a display unit, a graphical user interface (GUI) for receiving at least one of a selection of the subject and a setting of the crop region,
wherein, in the displaying, a first GUI component and a second GUI component respectively indicating the selected subject and the crop region are displayed on the display unit.

8. A control apparatus control method for controlling an image capturing device,
the image capturing device having a tracking function for tracking and capturing a video of a subject, and a crop function for generating a crop video obtained by cropping the captured video and cutting out a partial region from the captured video, and
the control apparatus being configured to be capable of setting, to the image capturing device, a setting of a target position in the captured video within which the subject is to stay in the tracking function, and a crop region in the captured video that is to be cut out by the crop function,
the control method comprising:
displaying, on a display unit, a graphical user interface (GUI) for receiving at least one of a setting of the target position and a setting of the crop region; and
setting, to the image capturing device, a setting of the target position and a setting of the crop region received via the GUI,
wherein, in the displaying, a first GUI component and a second GUI component that respectively indicate the target position and the crop region are displayed on the display unit.

9. A control apparatus control method for controlling an image capturing device,
the image capturing device having a tracking function for tracking and capturing a video of a subject, and a crop function for generating a crop video obtained by cropping the captured video and cutting out a partial region from the captured video, and
the control apparatus being configured to be capable of setting, to the image capturing device, a selection of a subject to be a tracking target in the tracking function from among a plurality of subjects in the captured video, and a crop region in the captured video that is to be cut out by the crop function,
the control method comprising:
displaying, on a display unit, a graphical user interface (GUI) for receiving at least one of a selection of the subject and a setting of the crop region; and
setting, to the image capturing device, a selection of the subject and a setting of the crop region received via the GUI,
wherein, in the displaying, a first GUI component and a second GUI component respectively indicating the selected subject and the crop region are displayed on the display unit.

10. A non-transitory computer-readable recording medium storing a program that, when executed by a computer, causes the computer to perform a control apparatus control method for controlling an image capturing device,
the image capturing device having a tracking function for tracking and capturing a video of a subject, and a crop function for generating a crop video obtained by cropping the captured video and cutting out a partial region from the captured video, and
the control apparatus being configured to be capable of setting, to the image capturing device, a setting of a target position in the captured video within which the subject is to stay in the tracking function, and a crop region in the captured video that is to be cut out by the crop function,
the control method comprising:
displaying, on a display unit, a graphical user interface (GUI) for receiving at least one of a setting of the target position and a setting of the crop region; and
setting, to the image capturing device, a setting of the target position and a setting of the crop region received via the GUI,
wherein, in the displaying, a first GUI component and a second GUI component that respectively indicate the target position and the crop region are displayed on the display unit.

11. A non-transitory computer-readable recording medium storing a program that, when executed by a computer, causes the computer to perform a control apparatus control method for controlling an image capturing device,
the image capturing device having a tracking function for tracking and capturing a video of a subject, and a crop function for generating a crop video obtained by cropping the captured video and cutting out a partial region from the captured video, and
the control apparatus being configured to be capable of setting, to the image capturing device, a selection of a subject to be a tracking target in the tracking function from among a plurality of subjects in the captured video, and a crop region in the captured video that is to be cut out by the crop function,
the control method comprising:
displaying, on a display unit, a graphical user interface (GUI) for receiving at least one of a selection of the subject and a setting of the crop region; and
setting, to the image capturing device, a selection of the subject and a setting of the crop region received via the GUI,
wherein, in the displaying, a first GUI component and a second GUI component respectively indicating the selected subject and the crop region are displayed on the display unit.
